(19) United States
(12) Patent Application Publication
(10) Pub. No.: US 2004/0180700 A1
(43) Pub. Date: Sep. 16, 2004

(54) Subscriber identity module and terminal therefor

(76) Inventors: Pascal Hubbe, Paris (FR); Pierre Gobin, Paris (FR)

Correspondence Address: Sughrue Mion, Suite 800, 2100 Pennsylvania Avenue NW, Washington, DC, 20037-3213, US

(21) Appl. No.: 10/482,634

(22) PCT Filed: Jun. 20, 2002
(86) PCT No.: PCT/FR02/02143

(30) Foreign Application Priority Data
Jun. 28, 2001 (FR) 01/08581

(51) Int. Cl. H04M 1/00; H04B 1/38

(52) U.S. Cl. 455/567

(57) ABSTRACT

The invention relates to a subscriber identity module for use in a mobile radio terminal for identifying a first subscriber in a cellular telecommunication system. According to the invention, said module (7) includes a first file (EF_{Mic}) for customizing ringtones that is adapted to specify a ringtone from a predetermined library of ringtones to be played by sound reproducing means of the terminal if a second subscriber connected to the network attempts to contact the first subscriber.

The present invention relates to a subscriber identity module for a mobile radio terminal for identifying a first subscriber in a cellular telecommunication system.

Mobile radio terminals of the mobile telephone type generally include a display screen, a keypad with keys, a memory, generally of the Flash memory type, for temporarily storing one or more SMS messages received from the network, and a processor programmed to operate with the keys, the memory, and the display screen to display an SMS message or messages stored in the memory on the screen in response to one or more keystrokes.

They are further provided with a ringtone for alerting the user subscriber to the reception of a call or an SMS message. Generalization of the use of mobile telephones has been accompanied by diversification of the palette of services offered to subscribers. Thus offering subscribers the facility to customize their mobile telephone's ringtones is known in the art.

However, once a ringtone has been selected from a library of ringtones prestored in a memory of the telephone, it is activated for any incoming call from the network, with no facility to distinguish calls from friends from calls from business contacts, for example.

It has therefore come to be seen as beneficial to seek a solution providing subscribers with information relating to incoming calls, in particular for filtering purposes. Furthermore, it has also come to be seen as particularly beneficial to propose a universal solution for porting this information if the user changes terminal.

The invention therefore aims to solve the problem of distinguishing between incoming calls and incoming SMS text messages in a context of universal portability, so that the aforementioned distinguishing means are retained on changing mobile radio terminal.

To this end, the invention consists in a subscriber identity module for use in a mobile radio terminal for identifying a first subscriber in a cellular telecommunication system, which module is characterized in that it includes a first file for customizing ringtones that is adapted to specify a ringtone from a predetermined library of ringtones to be played by sound reproducing means of the terminal if a second subscriber connected to the network attempts to contact the first subscriber.

Accordingly, when a call or an SMS text message is received, the subscriber is alerted to the call attempt by the ringtone specific to the second subscriber.

Furthermore, the ringtone customization file being stored in the subscriber identity module, it can be transposed when changing terminal, given that the subscriber identity module is generally a smart card or a smart token that is removable.

In this way, if the user subscriber has customized the ringtone corresponding to the second subscriber, that customization will not be lost on transferring the subscriber identity module from one mobile radio terminal to another. Furthermore, the invention offers the possibility of linking each stored subscriber to a dedicated ringtone.

In an embodiment, the ringtone customization file contains means for identifying the location of the ringtones.

In an embodiment, the ringtone location identification means provide an indication of a location in the module or in the terminal and/or of the absence of ringtones, leading by default to activation of the vibrator mode of the terminal.

In an embodiment, said ringtone customization means include means for identifying groups of telephone numbers, each group having a particular ringtone, the fact that the second subscriber belongs to one of said groups leading to assigning the ringtone associated with that group.

In an embodiment, the ringtone information is coded in accordance with a predetermined coding scheme.

The invention also consists in a mobile radio terminal for mobile radio communication in a cellular telecommunication system, which terminal is characterized in that it includes a module of the invention.

The invention will be better understood on reading the following description and examining the accompanying drawings. The drawings are given by way of indication only and are in no way limiting on the invention. The drawings show:

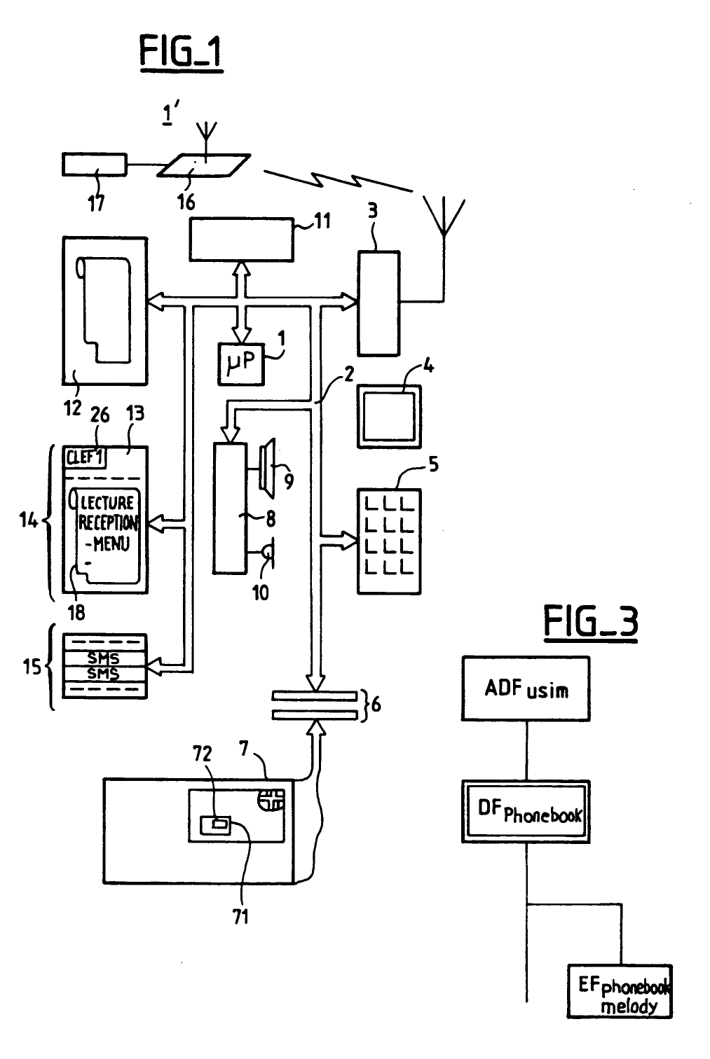

FIG. 1: a diagram of the architecture of a mobile telephone.

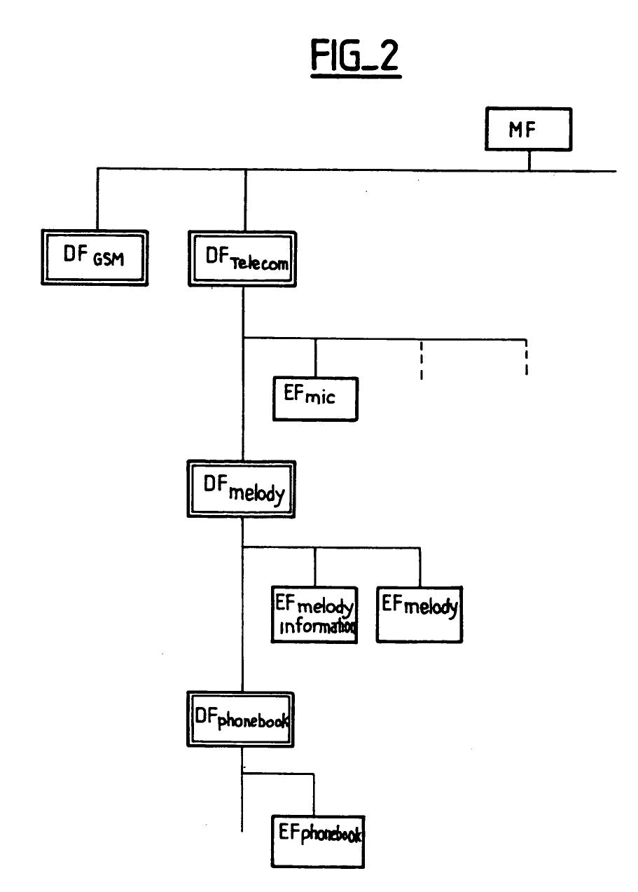

FIG. 2: a file tree structure in a master directory file of an embodiment of the module of the invention.

FIG. 3: a file tree structure in an application directory file of an embodiment of the module of the invention.

FIG. 1 shows a mobile telephone 1′ that essentially comprises a microprocessor 1 connected by a bus 2 to a set of circuits that essentially comprise a radio transceiver 3, a display screen 4, a control keypad 5, and an interface 6 for communication with a subscriber identity module 7 of the invention. In an embodiment, the module 7 is contained in a smart card or a smart token. The microprocessor 1 is further connected to speech processing circuits 8 connected to a loudspeaker 9 and to a microphone 10. The bus 2 is also connected to a set of memories. Thus there are shown a working memory 11, for example of the dynamic type, a program memory 12, which is preferably of the nonvolatile type, and a data memory 13, which is in particular of the nonvolatile, erasable, and programmable Flash EPROM type. The memory 13 contains the operating system of the microprocessor 1. The memory 13 can include a portion 14 that is preprogrammed when the mobile telephone is shipped to a client and a portion 15 that can be programmed as and when the telephone is used.

Any other architecture can be envisaged, however. The breakdown of the memories described here is by way of indication only.

The use of the mobile telephone in any type of cellular telecommunication system can be envisaged, for example of the Global System for Mobile communications (GSM) type or the Universal Mobile Telecommunications System (UMTS) type.

The subscriber identity module (SIM), or the universal subscriber identity module (USIM) in the case of the UMTS, includes a table 71 of services that is stored in a memory system 72 of the module 7; this memory system is referred to in the remainder of this application as the memory 72.

FIG. 2 shows more specifically the tree structure of the list of files stored in the memory 72 of the module in one embodiment of the invention.

A master file MF contains a plurality of subfiles consisting of files referred to as directory files and elementary files, a directory file being a parent file of an elementary file. Of the subfiles in the master file MF, FIG. 2 shows a directory file DF_{Telecom} which can contain an elementary file, not shown, EFₚₗ (“Elementary File for preferred languages”), for example containing data on the preferred languages of the user, etc.

The directory file DF_{Telecom} itself contains a directory file DF_{Graphic} that is the parent of an elementary file Ef_{Image} (not shown), an elementary file EF_{Mic} (“Elementary File for Melody (i.e. ringtone) related for incoming calls”) containing data relating to ringtones linked to incoming calls, and a directory file DF_{Melody} that is the parent file of elementary files EF_{Melodyinformation} containing ringtone information and EF_{Melodydata} containing data constituting the ringtones themselves (see below).

The directory file DF_{Telecom} further contains a directory file DF_{Phonebook} that is the parent file of an elementary file EF_{Phonebookmelody}.

In this embodiment, the elementary files contained in the directory file DF_{Melody} contain ringtone information. This directory file is not necessarily linked directly to the input of the phonebook directory file. In fact, it can be used directly by a man-machine interface of the terminal. However, it is assumed that in this embodiment DF_{melody} is linked to DF_{Phonebook}.

The content and the function of the file EF_{Mic} are described first. This file contains telephone numbers linked to their corresponding ringtones. For known caller numbers, it contains identifiers for locating each of the corresponding ringtones and identifiers specific to the ringtones themselves, which are stored in the SIM card, in this example in the file EF_{Melodydata} (in a different embodiment, not described, at least some of them can be stored in the terminal). The file also contains means for displaying the source of incoming calls, for example the name and/or forename of a listed caller, thanks to the link with DF_{Phonebook}.

When the incoming call corresponds to a phonebook entry (i.e. when the incoming caller is known), the ringtone stored in the file EF_{Melodydata} is used only if no ringtone is already associated with that phonebook entry (i.e. if the user or the manufacturer of the terminal has not already prestored locally in the terminal a ringtone for the incoming call concerned).

As already stated, the file EF_{Mic} contains ringtone location information addressing the device or the location at which the ringtone information is located. For example, the address can be that on the SIM card or that of a memory space in the terminal. The type of coding used to code this address can be as follows: “00” for a ringtone on the SIM card, “01” for a ringtone in a memory space of the terminal itself, or “02” to indicate that the vibrator mode should be used as the default ringtone.

The ringtone identifier includes an address addressing a register in the file EF_{Melodydata} if the location of the ringtone is set at 00. Otherwise, if the ringtone location is set at 01, the content of the ringtone identifier addresses the number of the ringtone stored in the terminal. Finally, if the ringtone location is set at 02, the ringtone identifier is set to FF, for example, and is not interpreted by the terminal. If the terminal has no vibrator mode, the default ringtone of the terminal is used.

The file EF_{Mic} can also contain a group name identifier whose content indicates if the telephone number is part of a predetermined group. In this case, the identifier contains a reference to the name of the group. As a result, if an incoming call corresponds to a telephone number belonging to a group (a group of friends, for example), the name of the group can be displayed on the telephone screen by means known in the art.

The content and the function of the file DF_{Melody} are described next.

Each record of the elementary file EF_{Melodyinformation} identifies the various modes of one particular ringtone, a ringtone being identified by a record number of that ringtone.

The ringtone modes can be different according to how they are coded, using one of the ringtone coding schemes offered by the software of the terminal. Thus a ringtone can be coded in two modes, a first mode being monophonic and the second mode being polyphonic. For example, the k^{th} ringtone represents a company ringtone, for which there are i modes, each encoded using a different coding scheme. Accordingly, the i modes of the company ringtone are described in a record k of the file EF_{Melodyinformation}.

Thus the file EF_{Melodyinformation} contains information on correspondences with the number of ringtone modes. The content of this information is a bit giving the number of ringtone modes, which bit can be coded in binary.

The file EF_{Melodyinformation} therefore contains a ringtone mode descriptor whose content gives a description of the ringtone mode. As already explained, the expression “ringtone mode” means the coding scheme for the ringtone concerned. The coding of this descriptor includes a first bit for identifying the ringtone coding scheme used to encode said ringtone mode. For example, the mode “00” could correspond to a coding scheme specific to the manufacturer and the mode “01” to a coding scheme of the MIDI type. Bits 2 and 3 designate a ringtone mode file identifier (see below). These bits identify the elementary file EF_{Melodydata}, which is the data file of the ringtone mode containing ringtone data for the mode in question. Bits 4 and 5 specify the offset between the various modes, which is used to determine the offset between the start of the ringtone coded monophonically and the start of the ringtone coded polyphonically, for example. Bits 6 and 7 designate the length of the ringtone modes data. As a general rule, the ringtone modes data file EF_{Melodydata} is at a level below that of the directory file DF_{Melody} and there can be several of these files for each ringtone. The ringtone mode data is accessed using the ringtone mode descriptor supplied by the file EF_{Melodyinformation} (see above).

Given the files and the structure described, the terminal including the module of the invention operates in the following manner:

On receiving a call or a Short Message System (SMS) text message, the terminal verifies if the caller is stored in the file EF_{Mic} or in the phonebook, and if so triggers the associated ringtone, which is indicated in the file DF_{Melody}. Note that if a plurality of coding schemes exist for the same ringtone, and if there is no information to the contrary, the terminal is programmed to opt for the code providing the best reproduction (in this example, the polyphonic mode will be chosen).

The caller may also be listed in the phonebook of the terminal.

FIG. 3 shows a file tree listing the files in the application directory file ADF_{Usim} of the module 1′ in one embodiment of the invention. In this configuration, in which the directory file DF_{Phonebook} is directly attached to the file ADF_{Usim}, it may be advantageous to attach the file DF_{Phonebook} directly to the application directory file ADF_{Usim} in the manner shown, which avoids duplication of certain data or certain links.

1. A subscriber identity module for use in a mobile radio terminal (1′) for identifying a first subscriber in a cellular telecommunication system, which module (7) is characterized in that it includes a first file (EF_{Mic}) for customizing ringtones that is adapted to specify a ringtone from a predetermined library of ringtones to be played by sound reproducing means (9) of the terminal if a second subscriber connected to the network attempts to contact the first subscriber.

2. A module according to claim 1, characterized in that the ringtone customization file contains means (00, 01) for identifying the location of the ringtones.

3. A module according to claim 2, characterized in that said ringtone location identification means indicate a location in said module (SIM, 00) or a location in the terminal (01).

4. A module according to claim 3, characterized in that said ringtone customization means include means for identifying groups of telephone numbers, each group having a particular ringtone, the fact that the second subscriber belongs to one of said groups leading to assigning the ringtone associated with said group.

5. A module according to claim 4, characterized in that the ringtone information is coded using a predetermined coding scheme.

6. A mobile radio terminal for mobile radio communication in a cellular telecommunication system, characterized in that the terminal includes a module according to claim 1 or claim 6.
